(19) United States
(12) Patent Application Publication
(10) Pub. No.: US 2009/0198561 A1
(43) Pub. Date: Aug. 6, 2009

(54) Self learning method and system for managing agreements to purchase goods over time

(75) Inventors: Jonathan Otto, Palm Beach, FL (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(73) Assignee: RetailDNA, LLC, Lake Worth, FL (US)

(21) Appl. No.: 12/322,095

(22) Filed: Jan. 29, 2009

Related U.S. Application Data
(63) Continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 10/00; G06N 5/02; G06Q 30/00

(52) U.S. Cl. 705/10; 706/58; 705/7; 705/14

(57) ABSTRACT

A system for managing a purchase agreement, including: a memory element for at least one specially-programmed general purpose computer for storing an artificial intelligence program (AIP) and a purchase agreement between a customer and at least one business entity, the purchase agreement including at least one requirement regarding at least one retail transaction between the customer and the business entity; a processor in the specially-programmed general purpose computer for: compiling a purchasing history for the customer with respect to the business entity and the purchase agreement, the memory element for storing the purchasing history, and modifying, using the purchasing history and the AIP, the at least one requirement to increase revenue or profitability of the business entity; and an interface element in the specially-programmed general purpose computer for transmitting the modified at least one requirement for presentation to the customer.

### CROSS-REFERENCE TO RELATED APPLICATIONS

This is a continuation-in-part patent application under 35 USC 120 of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for managing a purchasing agreement and, more particularly, to a method and system for providing such management using artificial intelligence.

### BACKGROUND OF THE INVENTION

The management of purchasing agreements is known, for example, as disclosed in U.S. Published Patent Applications 2007/0250388 (Walker et al.), incorporated by reference herein.

### SUMMARY OF THE INVENTION

The invention broadly comprises a system for managing a purchase agreement, including: a memory element for at least one specially-programmed general purpose computer, for storing an artificial intelligence program (AIP), and a first purchase agreement between a customer and at least one business entity, the first purchase agreement including at least one first requirement regarding at least one first retail transaction between the customer and the at least one business entity; a processor in the at least one specially-programmed general purpose computer for: compiling a first purchasing history for the customer with respect to the at least one business entity and the first purchase agreement, the memory element for storing the first purchasing history and modifying, using the processor, the first purchasing history, and the AIP, the at least one first requirement to increase revenue or profitability of the at least one business entity; and an interface element in the at least one specially-programmed general purpose computer for transmitting the modified at least one first requirement for presentation to the customer.

In one embodiment, the processor is for: modifying the at least one first requirement using an operational or financial parameter regarding the at least one business entity; or generating, using the processor and the AIP, the first purchase agreement to optimize revenue or profitability of the at least one business entity. In another embodiment, the processor is for generating the first purchase agreement using an operational or financial parameter regarding the at least one business entity, or using a second purchasing history for the first customer.

In one embodiment, the memory element is for storing a second purchase agreement between the customer and the at least one business entity, the second purchase agreement including at least one second requirement regarding at least one second retail transaction between the customer and the at least one business entity; and the processor is for: compiling a second purchasing history for the customer with respect to the at least one business entity and the at least one second purchase agreement, the memory element for storing the respective second purchasing history in the memory element; determining, using the first and second purchasing histories, a relative profitability of the first and second purchasing agreements; and modifying, using the relative profitability and the AIP, the first or second requirement to increase revenue or profitability of the at least one business entity.

In one embodiment, the interface element is for receiving an offer from the customer to enter into a third purchase agreement with the at least one business entity, the third purchase agreement including at least one third requirement regarding at least one third retail transaction between the customer and the at least one business entity, and the processor is for: determining a profitability of the third purchase agreement; and for a profitability less than a specified value, modifying, using the processor and the AIP, the at least one third requirement to increase revenue or profitability of the at least one business entity. The interface element is for transmitting the modified at least one third requirement.

In one embodiment, the processor is for determining, using the AIP, an incentive with respect to compliance with the first purchase agreement and the interface element is for transmitting the incentive with the modified at least one first requirement.

The invention also broadly comprises a system for managing a purchase agreement, including: a memory element for at least one specially-programmed general purpose computer for storing an artificial intelligence program (AIP); a processor for the at least one specially-programmed general purpose computer for: generating, using the AIP, a first purchase agreement between a customer and at least one business entity, the first purchase agreement to optimize revenue or profitability of the at least one business entity and including at least one first requirement regarding at least one first retail transaction between the customer and the at least one business entity; compiling a first purchasing history for the customer with respect to the at least one business entity and the first purchase agreement, the memory element for storing the first purchasing history; and modifying, using the first purchasing history and the AIP, the at least one first requirement to increase revenue or profitability of the at least one business entity; and an interface element in the at least one specially-programmed general purpose computer for transmitting, the modified at least one first requirement for presentation to the customer.

The invention further broadly comprises a system for managing a purchase agreement, including: an interface element for at least one specially-programmed general purpose computer for receiving an offer from a customer to enter into a purchase agreement with at least one business entity, the first purchase agreement including at least one first requirement regarding at least one first retail transaction between the customer and the at least one business entity; a memory element for the at least one specially-programmed general purpose computer for storing an artificial intelligence program (AIP); and a processor for the at least one specially-programmed general purpose computer for: determining a profitability of the first purchase agreement; and for a profitability less than a specified value, modifying, using the AIP, the at least one first requirement to increase revenue or profitability of the at least one business entity. The interface element is for transmitting the modified at least one first requirement for presentation to the customer.

The invention still further broadly comprises a method for managing a purchase agreement.

It is a general object of the present invention to provide a system and a method to manage a purchasing agreement that is dynamic and can be readily adapted to meet various and variable requirements.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing Figures, in which:

FIG. 1 is a schematic block diagram of a present invention system for managing a purchase agreement;

FIG. 2 is a flow chart illustrating a present invention computer-based method for managing a purchase agreement;

FIG. 3 is a flow chart illustrating a present invention computer-based method for managing a purchase agreement; and

FIG. 4 is a flow chart illustrating a present invention computer-based method for managing a purchase agreement.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

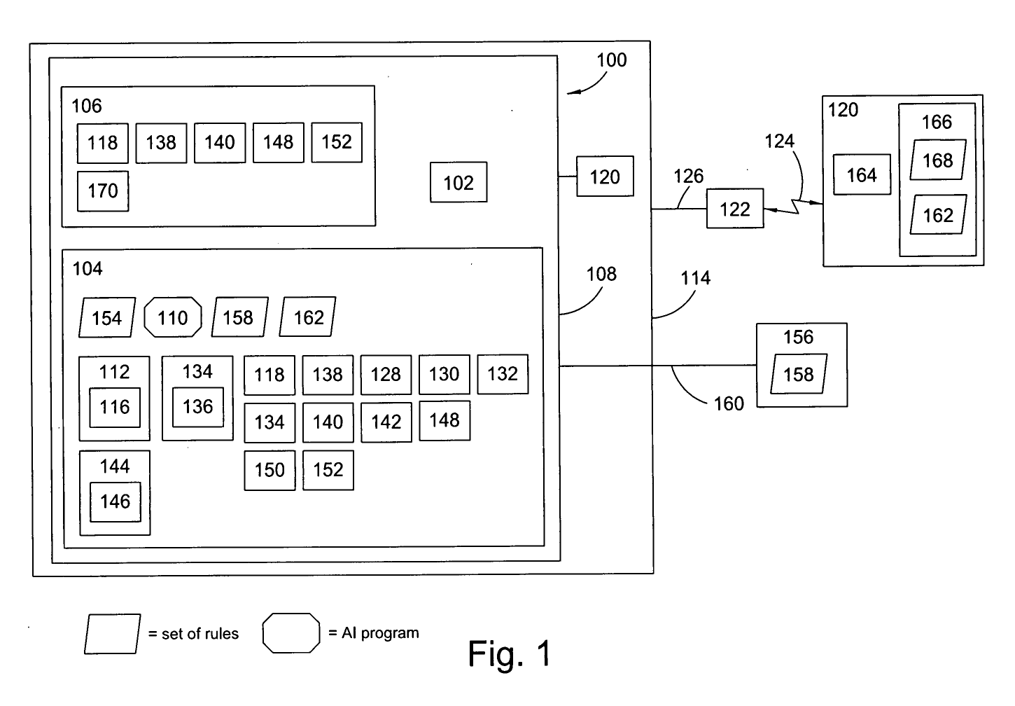

FIG. 1 is a schematic block diagram of present invention system 100 for managing a purchase agreement. The system includes interface element 102, memory element 104, and processor 106 for at least one specially programmed general-purpose computer, for example, computer 108. The memory element is for storing artificial intelligence program (AIP) 110, and purchase agreement 112 between a customer (not shown) and at least one business entity, for example, a business entity associated with location 114. The purchase agreement includes at least one requirement, for example, requirement 116, regarding at least one retail transaction between the customer and the business entity. The processor compiles a purchasing, or transaction, history 118 for the customer with respect to the business entity and the purchase agreement and the memory element stores the purchasing history. Hereinafter the terms “purchasing history” and “transaction history” are used interchangeably. The processor is for modifying, using the purchasing history and the AIP, requirement 116 to increase revenue or profitability of the business entity. The interface element transmits the modified requirement for presentation to the customer.

By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. Processor 106 and interface element 102 can be any processor or interface element, respectively, or combination thereof, known in the art.

Computer 108 can be any computer or plurality of computers known in the art. In one embodiment, the computer is located in a retail location with which system 100 is associated, for example, location 114. In another embodiment (not shown), all or parts of the computer are remote from retail locations with which system 100 is associated. In a further embodiment, computer 108 is associated with a plurality of retail locations with which system 100 is associated. Thus, the computer provides the functionality described for more than one retail location.

In one embodiment, requirement 116 is transmitted for presentation on a wireless communications device (WCD), for example, WCD 120. WCD 120 can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to interaction of the WCD and system 100. In another embodiment, requirement 116 is transmitted for presentation on any point of sale (POS) station known in the art, for example, POS station 120 in location 114. In a further embodiment (not shown), requirement 116 is transmitted for presentation on any device, remote from a location associated with the first business entity, such as location 114, known in the art, for example, a remote kiosk.

In one embodiment, a WCD usable with system 100, for example, WCD 120, is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 122, via radio-frequency connection 124. Network 122 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 122 using any means known in the art, including, but not limited to a hardwire connection, an optical connection, an Internet connection, or a radio frequency connection. In the figures, a non-limiting example of a hardwire connection 126 is shown. In one embodiment, device 120 is connectable to a docking station (not shown) to further enable communication between device 120 and system 100. Any docking station or docking means known in the art can be used. That is, when the device is connected to the docking station, a link is established between the device and system 100.

In one embodiment, the processor is for modifying requirement 116 using operational or financial parameter 128 regarding the business entity or the processor is for generating, using the AIP, the purchase agreement to increase revenue or profitability of the at least one business entity. In another embodiment, the processor is for generating the purchase agreement using operational or financial parameter 130 regarding the at least one business entity, or purchasing history 132 for the first customer. In general, at least a portion of history 132 pre-dates history 118. In a further embodiment, parameters 128 and 130 are the same. In yet another embodiment, one, some, or all of parameters 128 and 130 and history 132 are stored in the memory element.

In one embodiment, the memory element is for storing purchase agreement 134 between the customer and the business entity, purchase agreement 134 including at least one requirement, for example, requirement 136, regarding at least one retail transaction between the customer and the business entity. The processor compiles purchasing history 138 for the customer with respect to the business entity and purchase agreement 134, and the memory element stores history 138 in the memory element. The processor also determines, using histories 118 and 138, relative profitability 140 of purchasing agreements 112 and 134 and modifies, using profitability 140 and the AIP, at least one of requirements 116 or 136 to increase revenue or profitability of the business entity.

In one embodiment, the interface element receives offer 142 from the customer to enter into purchase agreement 144 with the business entity. Purchase agreement 144 includes at least one requirement, for example, requirement 146 regarding at least one retail transaction between the customer and the business entity. The memory element stores the offer and the processor determines profitability 148 of purchase agreement 144 and when the profitability is less than specified value 150, which can be stored in the memory element, the processor modifies, using the AIP, requirement 146 to increase revenue or profitability of the business entity. The interface element transmits modified requirement 146 for presentation to the customer.

### Correlate Transactions.

In one embodiment, the processor is for determining, using the AIP, incentive 152 with respect to compliance of the customer, for example, the customers purchasing activities, with purchase agreement 112. The interface element transmits the incentive with the modified requirement 116.

In one embodiment, the processor generates, using the AIP, purchase agreement 112.

In one embodiment, the present invention includes a rewards program in which one or more customers, or consumers, agree to purchase a set number of a certain products or services over a fixed period of time from a business entity, such as a retailer, for example, as described for agreements 112 and 134. In one embodiment, the programmed is managed, in whole or in part, by a self learning system or algorithm, for example, the AIP, so that agreements are adjusted in response to the performance of previous agreements to maximize revenue and profit for a retailer.

In one embodiment, the self learning system adjusts agreements based on the performance of one or more of the following parameters:
1. complaints registered by consumers about a current agreement.
2. cancellations or reversals of a current agreement.
3. modification requests submitted by consumers to adjust a current agreement.
4. The profitability of the customer or class of customers associated with agreements.
5. The revenue and or profit generated by the business entity as a result of an agreement or group of agreements.
6. The subsidy a manufacturer is willing to provide for a product included in an agreement.
   Although specific parameters are noted above, it should be understood that other parameters are within the spirit and scope of the claimed invention.

In one embodiment, the self learning system controls the following aspects of an agreement:
1. When and how subscription reminders for agreements are sent to consumers. For example, an email reminder can be sent to a customer about their agreement two days before their next purchase is due.
2. The retailers from whom an item can be purchased.
3. Products or services included in subscription agreements. Whether or not the manufacturer of a product is willing to subsidize the agreement can have an effect on this.
4. The total dollar amount or number of products or services needed to be purchased to fulfill an agreement.
5. Price per unit of items included in an agreement.
6. Purchase frequency for an agreement
7. Frequency term of an agreement
8. Start and end dates of an agreement
   Although specific aspects are noted above, it should be understood that other aspects are within the spirit and scope of the claimed invention.

In one embodiment, the present invention makes offers for a subscription agreement to a customer by stipulating that an item in a current transaction is free as long as the customer agrees to the subscription agreement. If the customer fails to honor the agreement, the purchase price for the original item is retroactively charged to an account for the customer, for example, a credit card.

In one embodiment, a rebate check for the full purchase price of an item can be applied to an account for the customer, for example, a debit account, if the customer fulfills a subscription agreement offered at the time of purchase.

In one embodiment, a customer can have respective subscription agreements with multiple business entities. An end user device, for example, WCD 120, can track subscription agreements with the multiple business entities. Messages, for example, respective prompts to remind the customer of their subscription obligations, can be transmitted from any or all of the business entities to the device.

In one embodiment, the present invention creates teams of consumers that agree to one or more subscription agreements to get a group reward. In another embodiment, consumers can register as teams, and the present invention can output a list of agreements available to the team based on the respective purchase histories of the team members.

In one embodiment, the memory element stores at least one rule 154. In general, rule 154 can be used in place of or in conjunction with the AIP in any or all of the operations described infra and supra regarding the processor or the AIP. For example, the processor uses the rule in one or more of the following operations: to compile a purchasing history, for example, history 118, for the customer with respect to the business entity and a purchase agreement, for example, agreement 112; to modify at least one requirement, for example, requirement 116, to increase revenue or profitability of the business entity; to modify the at least one requirement, for example, requirement 116, using an operational or financial parameter, for example, parameter 128, regarding the business entity; to generate a purchase agreement, for example, agreement 112, to increase revenue or profitability of the business entity; to compile a purchasing history, for example, history 138, for the customer with respect to the business entity and a purchase agreement, for example, agreement 134; to determine, using purchasing histories, for example, histories 118 and 138, a relative profitability, for example, profitability 140, of agreements; to modify, using the relative profitability, one or both of the requirements, for example, requirements 116 and 136, associated with the agreements to increase revenue or profitability of the business entity; to determining a profitability, for example, profitability 148, of a purchase agreement, for example, agreement 144, the agreement received as part of an offer, for example, offer 142 from the customer, the agreement including at least one requirement, for example, requirement 146, regarding at least one retail transaction between the customer and the business entity; for a profitability, for example, profitability 148, less than a specified value, for example, value 150, modifying the requirement, for example, requirement 146, to increase revenue or profitability of the at least one business entity; or to determining an incentive, for example, inventive 152, with respect to compliance with a purchase agreement, for example, agreement 112.

In one embodiment, the processor generates or modifies rule 154 using the AIP. In another embodiment, the rule is modified using the AIP according to the operations described in the preceding paragraph. Thus, the present invention is self-learning with respect to the rule and the rule can be automatically modified according to feed-back, modifications, or other benchmarks. It should be understood that a modified rule 154 can be used for any or all of the operations described supra or infra for rule 154. Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the operation of the AIP and rule 154.

In one embodiment, computer 156, separate from computer 108, transmits modifying rule 158 to computer 108. Computer 156 can be in location 114 (not shown) or can be in a different location. Computer 156 can be associated with a business entity associated with location 114 or can be associated with a different business entity. Connection 160 between computers 108 and 156 can be any type known in the art. In another embodiment (not shown), multiple computers 156 are included and respective computers among the multiple computers can be associated with the same or different business entities. Computer 108 stores modifying rule 158 in memory 104.

In one embodiment, rule 158 is used with or in place of rule 154, or is used in conjunction with the AIP. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of computer 108 with respect to rule 158.

In one embodiment, computer 108 receives at least one modifying rule 162 from a WCD associated with the customer, for example, WCD 120, and stores the rule in memory 104. In one embodiment, rule 162 is used with or in place of rule 158, or is used in conjunction with the AIP. Commonly owned U.S. patent application Ser. No. 12/151,043, filed May 2, 2008 and entitled “Method and System For Centralized Generation of a Business Executable Using Genetic Algorithms and Rules Distributed Among Multiple Hardware Devices” is applicable to the respective operations of computer 108 with respect to rule 162.

In one embodiment, a WCD, for example, WCD 120, with a processor and a memory element, for example, processor 164 and memory 166, is usable to receive an agreement, for example, agreement 112, or an incentive, for example, incentive 152. The memory element for the WCD stores at least one rule, for example, rule 168 and the processor for the WCD executes the agreement or the incentive according to the rule. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to the operations described regarding WCD 120, processor 164, rule 168, and presentation of the agreement or the incentive.

In one embodiment, the incentive can be an offer related to a good or service. The good or service can be any good or service known in the art. The following commonly-owned U.S. patent applications are applicable to the use of the AIP and or the rules described supra to generate an incentive including an offer: U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application Ser. No. 12/151,043, titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; commonly-owned U.S. patent application Ser. No. 12/151,038, titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008; commonly-owned U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. patent application Ser. No. 12/151,042, entitled “METHOD AND SYSTEM FOR GENERATING AN OFFER AND TRANSMITTING THE OFFER TO A WIRELESS COMMUNICATIONS DEVICE”, filed May 2, 2008; commonly-owned U.S. Pat. Application entitled “SYSTEM AND METHOD FOR PROVIDING INCENTIVES TO AN END USER FOR REFERRING ANOTHER END USER”, inventors Otto et al., filed Jul. 9, 2008; commonly-owned U.S. Pat. Application entitled “METHOD AND SYSTEM FOR GENERATING A REAL TIME OFFER OR A DEFERRED OFFER”, inventors Otto et al., filed Jul. 9, 2008; commonly-owned U.S. Pat. Application entitled “METHOD AND APPARATUS FOR GENERATING AND TRANSMITTING AN IDEAL ORDER OFFER”, inventors Otto et al., filed Jul. 9, 2008; commonly-owned U.S. Pat. Application entitled “SYSTEM AND METHOD FOR GENERATING AND TRANSMITTING LOCATION BASED PROMOTIONAL OFFER REMINDERS”, inventors Otto et al., filed Jul. 9, 2008; commonly-owned U.S. Pat. Application entitled “SYSTEM AND METHOD FOR LOCATION BASED SUGGESTIVE SELLING”, filed Jul. 9, 2008; and commonly-owned U.S. patent application entitled “SYSTEM AND METHOD FOR SCANNING A COUPON TO INITIATE AN ORDER”, filed May 2, 2008.

Any measure or metric known in the art can be used as parameter 128, including, but not limited to optimizing or maximizing revenues, profits, item counts, average check, market basket contents, marketing offer acceptance, store visitation or other frequency measures, or improving or optimizing speed of service, inventory levels, turns, yield, waste, or enhancing or optimizing customer loyalty or use of kiosks or internet or other POS devices, or use of off peak or other coupons or acceptance of upsell or other marketing offers, or reduction or optimization of any customer or employee or any other person's gaming, fishing, or any other undesirable action or activities and/or failures to act when desired, or minimizing or optimizing any dilution or diversion of sales, profits, average check, or minimizing or optimizing use of discounts and other promotions so as to maximize or optimize any of the foregoing desired actions, outcomes or other desired benefits, or any combination of minimizing undesired results while maximizing or optimizing any one or more of any desired results.

In one embodiment, the processor is for generating or modifying format or temporal parameter 170 for presentation of an agreement, reminders regarding an agreement, or an incentive. For example, the parameter is with respect to a time of day, week, month, or year at which the desired transaction or incentive is presented, or with respect to a frequency with which the presentation of an agreement, reminders regarding an agreement, or an incentive is presented. The presentation of an agreement, reminders regarding an agreement, or an incentive is transmitted according to parameter 170. In another embodiment, the processor uses the AIP to generate or modify parameter 170. For example, the parameter can be generated or modified according to parameter 128 or according to profitabities, such as 138 or 148.

Commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007, is applicable to the operations involving the AIP or any rules, noted supra and infra.

The discussion in commonly-owned U.S. patent application Ser. No. 11/983,679, filed Nov. 9, 2006 and entitled “Method and System for Generating, Selecting, and Running Executables in a Business System Utilizing a Combination of User Defined Rules and Artificial Intelligence” is applicable to modification of agreement 112, 134, or 144, or the incentive by the processor and the AIP or rules 154, 158, or 162.

As disclosed in commonly-owned U.S. Patent Application titled: “METHOD AND APPARATUS FOR GENERATING AND TRANSMITTING AN IDEAL ORDER OFFER,” inventors Otto et. al, filed Jul. 9, 2008, which application is incorporated by reference herein, in one embodiment, the processor reviews the transaction history to identify an item or service not included in the history (and presumably never ordered by the customer) or ordered by the customer at less than a predetermined frequency. Then, the processor, using the AIP, optimizes agreement 112, 134, or 144, or the incentive, for example, by including an upsell in the incentive for an item or service not included in the information or ordered at less than a predetermined frequency. In another embodiment, this pairing is used to realize the optimization of revenue or profits for the business entity.

It should be understood that various storage and removal operations, not explicitly described above, involving memory 104 and as known in the art, are possible with respect to the operation of system 100. For example, outputs from and inputs to the general-purpose computer can be stored and retrieved from the memory elements and data generated by the processor can be stored in and retrieved from the memory.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 114 or with a business entity operating the business location. It also should be understood that system 100 can be wholly or partly separate from the computer operating system for a retail location, for example, location 114, or with a business entity operating the business location.

It should be understood that although individual rule sets and a single artificial intelligence program are discussed, various of the individual rule sets can be combined into composite rules set (not shown). Further, the functions described for AIP 110 can be implemented by combinations of separate AIPs (not shown). Any combination of individual rule sets or artificial intelligence programs is included in the spirit and scope of the claimed invention.

In general, system 100, and in particular, the processor using the AI program, operates to use artificial intelligence, for example, a generic algorithm, to inform or make some or all of the decisions discussed in the description for FIG. 1. In one embodiment, system 100 performs the operations described herein to attain or maximize an objective of a business entity, for example, performance with respect to parameter 128. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables. Thus, the present invention, for example, system 100, specifically, computer 108 and processor 106, use artificial intelligence, for example, AIP 110 to automatically generate or modify operations, parameters, and outputs with respect to a goal, for example, a metric such as parameter 128 and automatically adapts the generation or modification operations, parameters, and outputs to feedback, that is, the present invention is self-learning and self-adapting with respect to generating or modifying operations, parameters, and outputs. Further, the present invention can automatically generate or modify the goal and be self-learning and self-adapting with respect to the goal.

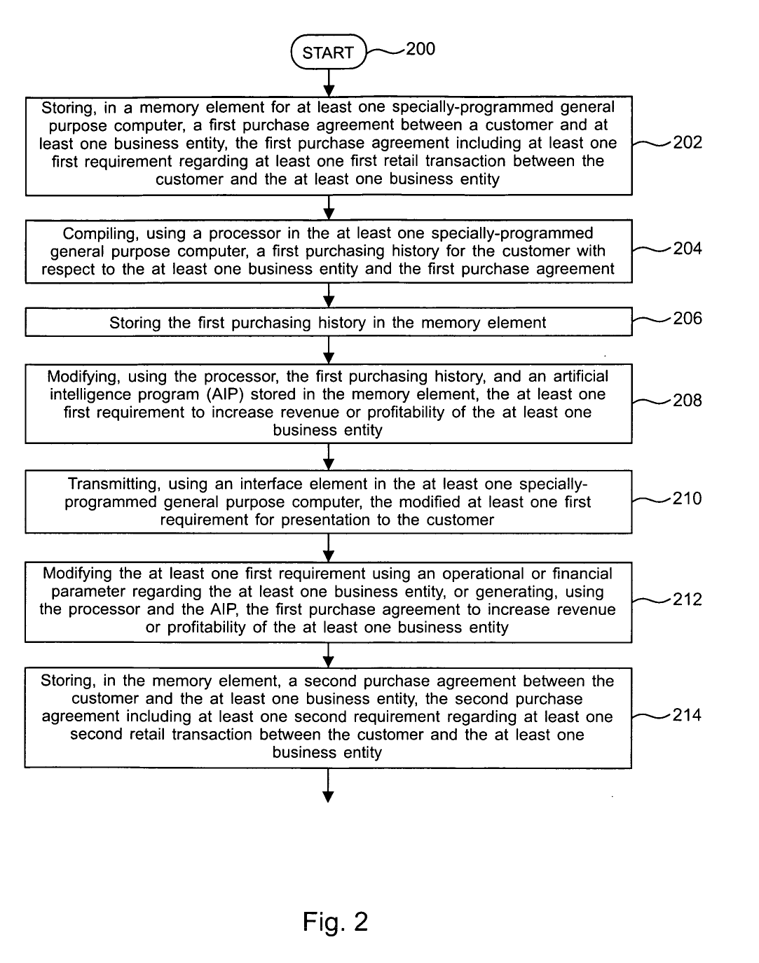

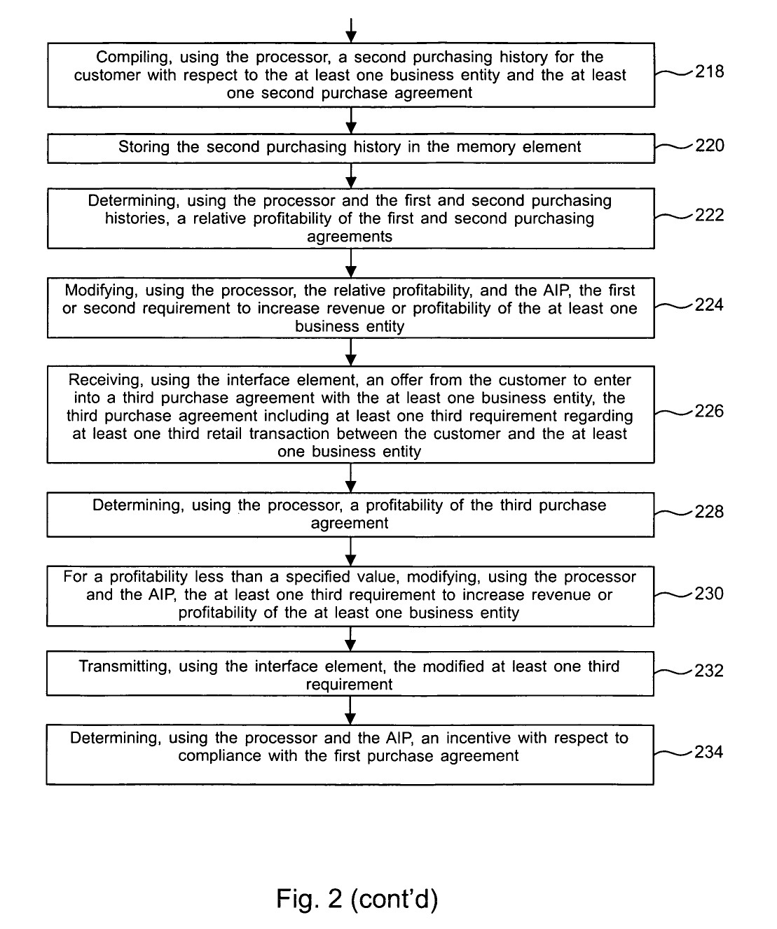

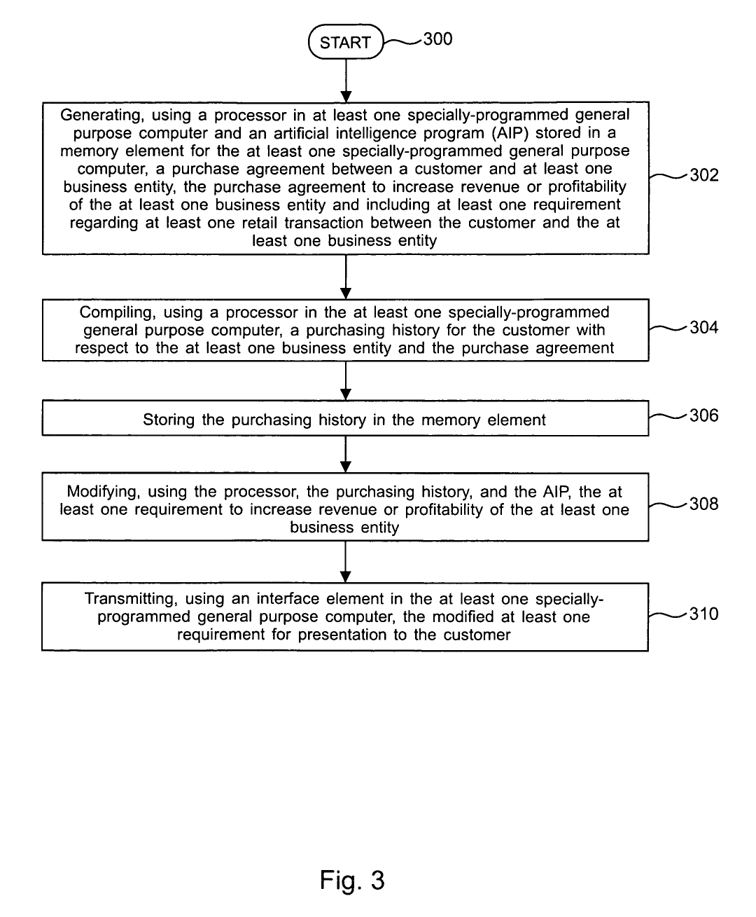

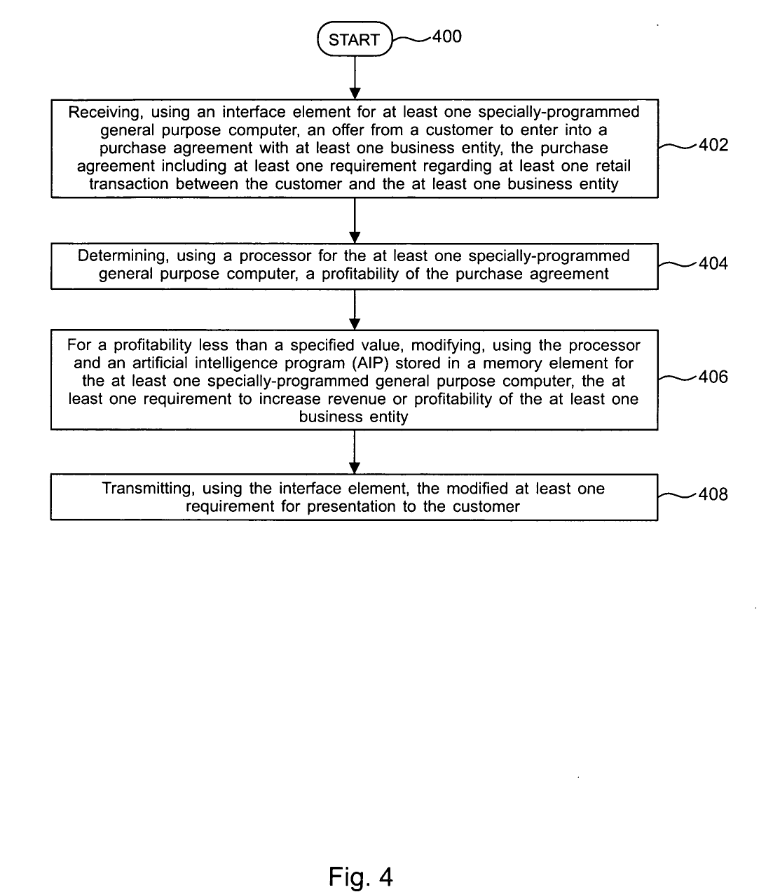

FIG. 2 is a flow chart illustrating a present invention computer-based method for managing a purchase agreement. Although the method in FIG. 2 (and FIGS. 3 and 4 below) is depicted as a sequence of numbered steps for clarity, no order should be inferred from the numbering unless explicitly stated. The method starts at Step 200. Step 202 stores, in a memory element for at least one specially-programmed general purpose computer, a first purchase agreement between a customer and at least one business entity, the first purchase agreement including at least one first requirement regarding at least one first retail transaction between the customer and the at least one business entity. Step 204 compiles, using a processor in the at least one specially-programmed general purpose computer, a first purchasing history for the customer with respect to the at least one business entity and the first purchase agreement. Step 206 stores the first purchasing history in the memory element. Step 208 modifies, using the processor, the first purchasing history, and an artificial intelligence program (AIP) stored in the memory element, the at least one first requirement to increase revenue or profitability of the at least one business entity. Step 210 transmits, using an interface element in the at least one specially-programmed general purpose computer, the modified at least one first requirement for presentation to the customer.

In one embodiment, step 212 modifies the at least one first requirement using an operational or financial parameter regarding the at least one business entity or generates, using the processor and the AIP, the first purchase agreement to optimize revenue or profitability of the at least one business entity. In another embodiment, generating the first purchase agreement includes using an operational or financial parameter regarding the at least one business entity, or using a second purchasing history for the first customer.

In one embodiment: step 214 stores, in the memory element, a second purchase agreement between the customer and the at least one business entity, the second purchase agreement including at least one second requirement regarding at least one second retail transaction between the customer and the at least one business entity; step 216 compiles, using the processor, a second purchasing history for the customer with respect to the at least one business entity and the at least one second purchase agreement; step 218 stores the respective second purchasing history in the memory element; step 220 determines, using the processor and the first and second purchasing histories, a relative profitability of the first and second purchasing agreements; and step 222 modifies, using the processor, the relative profitability, and the AIP, the first or second requirement to increase revenue or profitability of the at least one business entity.

In one embodiment: step 224 receives, using the interface element, an offer from the customer to enter into a third purchase agreement with the at least one business entity, the third purchase agreement including at least one third requirement regarding at least one third retail transaction between the customer and the at least one business entity; step 226 determines, using the processor, a profitability of the third purchase agreement; step 228, for a profitability less than a specified value, modifies, using the processor and the AIP, the at least one third requirement to increase revenue or profitability of the at least one business entity; and step 230 transmits, using the interface element, the modified at least one third requirement.

In one embodiment, step 232 determines, using the processor and the AIP, an incentive with respect to compliance with the first purchase agreement and transmitting the modified at least one first requirement includes transmitting the incentive.

FIG. 3 is a flow chart illustrating a present invention computer-based method for managing a purchase agreement. The method starts at step 300. Step 302 generates, using a processor in at least one specially-programmed general purpose computer and an artificial intelligence program (AIP) stored in a memory element for the at least one specially-programmed general purpose computer, a first purchase agreement between a customer and at least one business entity, the first purchase agreement to increase revenue or profitability of the at least one business entity and including at least one first requirement regarding at least one first retail transaction between the customer and the at least one business entity. Step 304 compiles, using a processor in the at least one specially-programmed general purpose computer, a first purchasing history for the customer with respect to the at least one business entity and the first purchase agreement. Step 306 stores the first purchasing history in the memory element. Step 308 modifies, using the processor, the first purchasing history, and the AIP, the at least one first requirement to increase revenue or profitability of the at least one business entity. Step 310 transmits, using an interface element in the at least one specially-programmed general purpose computer, the modified at least one first requirement for presentation to the customer.

FIG. 4 is a flow chart illustrating a present invention computer-based method for managing a purchase agreement. The method starts at step 400. Step 402 receives, using an interface element for at least one specially-programmed general purpose computer, an offer from a customer to enter into a first purchase agreement with at least one business entity, the first purchase agreement including at least one first requirement regarding at least one first retail transaction between the customer and the at least one business entity. Step 404 determines, using a processor for the at least one specially-programmed general purpose computer, a profitability of the first purchase agreement. Step 406, for a profitability less than a specified value, modifies, using the processor and an artificial intelligence program (AIP) stored in a memory element for the at least one specially-programmed general purpose computer, the at least one first requirement to increase revenue or profitability of the at least one business entity. Step 408 transmits, using the interface element, the modified at least one first requirement for presentation to the customer.

The following describes a present invention computer-based method for managing a purchase agreement. Although the method is presented as a sequence of steps for clarity, no order should be inferred from the sequence unless explicitly stated. To modify an existing agreement: a first step receives subscription program data; a second step alters program based on data; and a third step outputs alteration. To generate a new agreement, a first step receives subscription program data; a second step generates new subscription programs; and a third step stores new programs. To create a counter offer for requested agreement: a first step receives a consumer generated subscription program; a second step generates modification range (in one embodiment, range allows store employee to negotiate. Range could be one option if no employee negotiation is necessary) to optimize agreement; a third step outputs subscription programs, or agreements, with modification range; a fourth step receives modification in range; and a fifth step stores active subscription, or agreement.

The following should be viewed in light of FIGS. 1 through 4 and any discussion provided supra. Although the following non-limiting discussion is directed to a present invention system, it is understood that the discussion also is applicable to a present invention method. The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to generate or modify an agreement or incentive, for motivating a desired behavior by a customer. The present invention can use any, all, or none of the following considerations as part of generating or modifying an agreement, incentive, or parameter, or performing the operations described supra, for example, by adding programming logic, self-learning, and self-adaptation as noted supra: any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, current speed of service, quality of service or other operating data, budgets, objectives or trends, etc.

In one embodiment, the present invention employs any, all, or none of the following considerations as part of generating or modifying an agreement, incentive, or parameter, or performing the operations described supra, for example, by adding programming logic, self-learning, and self-adaptation as noted supra:
1. Parameters or data regarding a customer, for example, transaction history 118. For example, an agreement or incentive can be made more attractive to the customer if the customer is a loyal customer or if the business entity wishes to entice the customer to purchase a good seldom ordered by the customer in the past. Proclivity to accept or reject offers of the same or other types. Customer objectives also can be considered.
2. The customer class or type. For example, an agreement or incentive can be made more attractive to the customer if the customer is grouped with loyal customers or if the business entity wishes to entice the customer group to purchase a good seldom ordered by the customer group in the past. Customer group objectives also can be considered.
3. Temporal parameters, such as the time of day, week, month, or year. For example, the system can reduce prices in an agreement or incentive to encourage sales during times of historic low sales volume or increase prices in the incentive during times of historic high sales volume.
4. The good or service involved in a past, current, or possible future transaction between the customer and the business entity. For example, an agreement or incentive for items with a short shelf life can be made more attractive to encourage a larger volume of orders for the items.
5. Inventory on hand. For example, an agreement or incentive can be modified to encourage sale of overstocked items or to maximize profits for items in short supply.
6. Specifics of a transaction. With the use of the AIP, system 100 can automatically, dynamically, and intelligently adapt an agreement or incentive to any parameter associated with a particular transaction. Further, the parameters to which the system is to adapt the price can be automatically, dynamically, and intelligently selected or modified.
7. Physical parameters of the transaction process. For example: order entry device, e.g., point of sales (POS) terminal, kiosk, cell phone, PDA, laptop, IED, etc.; POS device or station, e.g., front counter, drive through, retail station, call center, location on counter, e.g., first station vs. second, third fourth or other station, etc.; output display device (e.g., customer facing display, kiosk, cell phone, PDA, laptop, IED, etc.); or in a quick serve restaurant, an agreement or incentive can be modified to encourage use of self-service kiosks, which may optimize revenue for the business entity, or to discourage use of a point of sales station attended by an employee.
8. Rate of sale of items. For example, prices in an agreement or incentive can be increased for goods that are selling rapidly or reduced for goods that are selling slowly.
9. Reservations. For example, to encourage customers to make reservations at a sit down restaurant, prices in an agreement or incentive can be reduced for orders placed by customers making reservations.
10. Regular orders. For example, based on the transaction history, prices in an agreement or incentive for a restaurant can be reduced for items regularly ordered by a customer or prices can be reduced on items rarely ordered by a customer to encourage the customer to order the rarely ordered items.
11. Employee. For example, to increase prices for an agreement or incentive handled by an employee with a high success rate of handling such incentives.
12. The nature of the transaction, for example, determining feasible upsells to include in an agreement or incentive.
13. The location at which the transaction is occurring, for example, lowering the price in an agreement or incentive to encourage patronage at a location.
14. Business Information or objectives, for example, parameter 128.
15. Sponsor Information or objectives.
16. Marketing Program Type.
17. Opt In Information.
18. Payment method or terms or conditions of payment.
19. Marketing Message Contents.
20. Marketing Offer Objectives.
21. Expected or Actual System Results or tracking data.
22. System determined discounts or other incentives required to achieve desired results.
23. One or more table entries provided by one or more end users, for example, a system administrator.
24. One or more rules provided by one or more end users, for example, a system administrator.
25. One or more genetic algorithms or other AI based rules or determination methods.
26. Point within transaction, e.g., pre-order, mid-order, post order, etc.
27. Loyalty program information.
28. Current store activity, e.g., high or low volumes of transactions.
29. Customer survey information.
30. Financial considerations, such as total current price/profit, total expected price/profit, regular or discounted price, gross margins, profit margins, labor rates, labor availability, marketing funds available, or third party funds available, budget.
31. Expectation of accept or reject of one or more offers in an agreement or incentive at one or more price points in the agreement or incentive.
32. Current, prior or expected level of dilution, gaming, fishing, accretion.
33. Business, customer, or employee target goals.
34. Current or planned local, regional or national or other marketing campaigns, including, for example, product introductions, price or other promotions, print, radio or television or other advertisements, e.g., newspaper coupon drops, etc.
35. Business, customer, sponsor, or system objectives.
36. Business, customer, sponsor, third party, or system information.
37. Any other information, data, rules, system settings, or otherwise available to the marketing system or disclosed invention or the POS system or other system designed to deliver one or more marketing messages, offers, or coupons, etc.
38. Any combination or priority ranking of any two or more of the foregoing.

In one embodiment, agreements, histories, incentives, or other parameters, are created or maintained centrally or in a distributed network, including, for example, locally. Such management may be accomplished via any applicable means available, including, for example, making use of existing, e.g., off the shelf or customized tools that provide for such creating, management or distribution.

In another embodiment, in an effort to further enhance generating or modifying an agreement, an incentive, or a parameter or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In one embodiment, each location associated with the present invention establishes its own rules, uses its own AIP or generic algorithm, or learns from local customer behavior or other available information. In another embodiment, the present invention shares some or all available information or results data among any two or more or all locations or locations that fall within a given area, region, geography, type, or other factors, such as customer demographics, etc., and makes use of such information to improve the present invention's ability to perform present invention operations described supra and infra.

For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of agreements or incentives are particularly effective. By sharing such information among other locations, for example, similar locations, the present invention can begin to make use of the same or similar agreements or incentives in other generally similar locations or with similar customers or classifications of customers so as to improve the performance of one or more other such locations or all locations. In this fashion, the present invention can learn which desired agreements or incentives generally achieve the desired results or improve trends towards such results. Likewise, the present invention can more quickly determine which agreements or incentives do not yield the desired results or determine how long such agreements or incentives are required to achieve the desired results.

In one embodiment, agreements or incentives are provided or subsidized by one or more third parties, including, for example, third party sponsors. For example, a vendor supplying an item in an agreement or incentive could subsidize the agreement or incentive to encourage acceptance of the item. In another example, such an offer may be partially or fully subsidized by an unrelated third party sponsor. For example, as part of an agreement or incentive, a telecommunications company offers to view an advertisement for telecommunications company or fill out a survey or perform some other action or accept a subsequent or related optional or required offer, etc.

In one embodiment, customers are grouped by the processor according to similarities in transaction history or other customer information, for example, using history 118 or 138. The system generates, modifies, or uses an agreement, incentive, or parameter per the grouped customers.

In one embodiment, the operations of the processor and the AIP, described supra and infra, include the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, the present invention generates, modifies, or uses an agreement, incentive, or parameter based upon other performance data or results, for example, the transaction history. In another embodiment, the present invention determines the impact of transaction histories, agreements, incentives, or presentations on the ability or proclivity of an employee or customer to game or fish the present invention. The system avoids or ceases transaction histories, agreements, incentives, or presentations and/or changes the type of transaction histories, agreements, incentives, or presentations provided or suppressed.

In one embodiment, transaction histories, agreements, incentives, or presentations vary from customer to customer or from time to time, or one or more of these may be consistent regardless of the customer, time, or other information. In a another embodiment, where transaction histories, agreements, incentives, or presentations vary, such transaction histories, agreements, incentives, or presentations are determined via any applicable means and using any available information to make such determination, including, for example, any available customer, account, business, or sponsor information or any one or more customer, account, business, or sponsor objectives or any combination of the forgoing. In a further embodiment, transaction histories, agreements, incentives, or presentations are further determined or modified based upon information or needs or business objectives of one or more suppliers or competitors of such suppliers. For example, if a WCD is within a geographical area for a location selling competing items A and B, an agreement or incentive are generated and transmitted for one or both of the items and vendors for the items underwrite the cost for the price to the business entity. In one embodiment, one or more of the above operations are performed using the AIP.

In one embodiment, a present invention system generates, modifies, or uses transaction histories, agreements, incentives, or presentations based upon current or previous buying habits or any other available information regarding a customer. If for example, an end user is a loyal customer for item A, the present invention can increase the price in the incentive for item A or decrease the price in the incentive for a different item depending upon any known factors, for example, did the customer receive or act upon an offer for item B. If the customer did receive or act upon a reminder for item B, in another embodiment, the present invention reduces a cost in the incentive for item A as a blandishments to purchase item A instead of item B, or matches or beats a price for item B, or queries such loyal (or other) customer to determine what price such customer would require to purchase item A. In this fashion a competitive environment is created.

In one embodiment, the end user of a present invention system modifies the rules or method of operation so as to favor itself. For example, in the previous example, if the producer of item A were the sole end user of the present invention, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, for example, the profitability or perceived or actual quality or consistency or pricing of such one or more suppliers. In one embodiment, one or more of the above operations are performed using the AIP.

In one embodiment, in order to receive an agreement or incentive, customers are required to opt in to a cellular marketing program or some other loyalty program indicating their desire or providing permission for such marketing system or the business entity to send one or more such agreement or incentive. In this fashion, only those interested in such communications will be sent such communications.

In a further embodiment, an agreement or incentive is modified for prospective customers having an identity previously provided by an existing customer, as described in commonly-owned U.S. patent application Ser. No. 12/217,863, titled: “SYSTEM AND METHOD FOR PROVIDING INCENTIVES TO AN END USER FOR REFERRING ANOTHER END USER,” inventors Otto et al., filed Jul. 9, 2008, which application is incorporated by reference herein. For example, if an existing quick service restaurant chain customer provides one or more prospective customer's identity, when such prospective customer is identified during a transaction with a quick service restaurant chain's participating location, the present invention generates or modifies an agreement or incentive or presentation of an agreement or incentive to encourage participation in the program and provides the identity of the referring party along with such agreement or incentive. In one embodiment, one or more of the above operations are performed using the AIP.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. Patent Application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. Patent Application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which agreements, incentives, or presentations generally yield the desired or optimal or generally better results, or such results may be determined using artificial intelligence, for example, one or more genetic algorithms, or a present invention administrator/operator can review results reports and then provide manual weighting criteria to further define or control the present invention, or a combination of these and other well known methods may be employed in any combination or in any order or priority.

In one embodiment, a present invention incentive includes a discount. Such discounts can be associated or applied to specific items, or to an entire order. In one embodiment, discounts are determined based upon rules established by management of the present invention or as established or modified from time to time by any authorized personnel, or may be initially established or modified using a learning system, e.g., a genetic algorithm. In any such case, the present invention can make use of any or all available information, including, but not limited to transaction history and customer information. Discounts can be designed to maximize, minimize or optimize any one or more business or customer objectives as desired or indicated. In another embodiment, the discount, if any, is presented to the customer as a percentage discount or as a cents or other amount off discount. In one embodiment, one or more of the above operations are performed using the AIP.

In one embodiment, discounts in incentives are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what price reductions, if any, are required given the known information. For example, if a customer has not complied with an agreement, the present invention could include a price offering a 10% discount in an incentive if the customer complies with the agreement. If the customer rejects such offer, the present invention could offer a larger discount in the incentive, for example, for a 20% discount. Once the present invention determines an agreement holder's price points, and/or a holder becomes habituated to executing agreements, the present invention can reduce or eliminate related discounts or other incentives. In one embodiment, one or more of the above operations are performed using the AIP.

In one embodiment, the present invention, having acquired data regarding customer price elasticity, compliance, or other information, uses such information to determine other agreements, incentives, or presentations for the same or generally similar customers, e.g., other customers who fail to comply with a type of agreement. In another embodiment, using such logic, the present invention determines classifications of customers and leverage use of such information by providing agreements, incentives, or presentations that also are optimized from the location or location management perspective/objectives. In one embodiment, one or more of the above operations are performed using the AIP.

In one embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what price modifications, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential pricing and modify such pricing or provide other incentives to drive a desired percentage of business or customer transactions to one or more particular devices, locations or payment methods. In one embodiment, one or more of the above operations are performed using the AIP.

In one embodiment, the present invention provides such incentives initially, or on an ongoing basis or only until certain objectives are achieved or certain customers or all customers are generally habituated to compliance to agreements, after which, in certain embodiments, the present invention may cease, temporarily or permanently making such price incentives based upon such discriminating factors, or may reduce the difference in incentives, or may only periodically provide such full discounts or reduced discounts so as to reinforce such behavior. In another embodiment, a system administrator or other end user establishes such rules or conditions. In one embodiment, one or more of the above operations are performed using the AIP.

In one embodiment, the present invention makes such determinations using an automated means. Such automated means includes, for example, a system that periodically or generally continuously tests different transaction histories, agreements, incentives, or presentations or other methods, for example, user interfaces, or other benefits or incentives, and based upon such testing, determine which transaction histories, agreements, incentives, or presentations or other benefits yield the desired compliance, for example, with a business objective. Such automated system may periodically cease providing such incentives once it is determined that the desired customer behavior has been established, habituated or otherwise persists without need for such continued incentive. If such system subsequently determines that the desired behavior has ceased or fallen below a desired level, such system can then reinstate an appropriate incentive. When reinstating such incentive, the present invention can return to previously successful levels, or can provide different transaction levels on a temporary, periodic or permanent basis. Such reinstatement may be provided for all customers, certain customers, classes of customers, or only those customers that have ceased or have generally reduced their frequency of desired behavior. In one embodiment, one or more of the above operations are performed using the AIP.

In one embodiment, the present invention tests transaction histories, agreements, incentives, or presentations or provides certain pricing on a periodic basis within a single location or among a plurality of locations so as to determine the extent or requirement regarding any such transaction histories, agreements, incentives, or presentations or other benefits. For example, by testing incentive levels, the present invention can determine the level of incentive needed to attain a business goal, or such a system can further determine the extent of any gaming, dilution, diversion or accretion. By alternating offering and not offering incentive modification or by testing various levels of incentives, the present invention can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such transaction histories, account data, metrics, desired transactions, incentives, or presentations or benefits, the present invention can continually strive to achieve the optimal mix and level of transaction histories, agreements, incentives, or presentations. By combining the use of one or more of a table, rules or AI based system, including, for example, as disclosed in the applications incorporated by reference herein, a more effective, responsive, adaptive, and dynamic marketing system may be developed and deployed that achieves optimal or nearly optimal results over both the short and long term.

In one embodiment, the present invention tests customers of one or more locations using, an incentive, for example, discounted pricing, while maintaining the regular prices at one or more other locations. By comparing the results data from such test and control groups of locations, the present invention can better determine which incentives are accretive or provide net benefit or are subject to gaming, fishing or other fraudulent or undesirable activities. Such testing can be performed within a single unit as well, by periodically offering such incentives to the same or similar customers or by randomly providing or not providing such incentives. In one embodiment, one or more of the above operations are performed using the AIP.

In one embodiment, the present invention makes use of a combination of such testing methodologies in order to best determine which agreements, incentives, or presentations yield optimal or the best results given the present invention information, parameters or any one or more customer, business, sponsor or present invention objectives. For example, the present invention tests in a single or group of stores certain new or untested agreements, incentives, or presentations, and, combines such test with a periodic modification of agreements, incentives, or presentations, for example, toggling, between higher and lower price discounts, which toggling, may be random, 50/50, or may be intelligently determined, for example, using the AIP, based upon system information, and continue such test for a period of time, for example, one month, while comparing results of such tests with a similar number of stores in a control group, and then, switch the process, for example, test within the original control group and stop offering modified agreements, incentives, or presentations within the original test group. In this fashion the present invention determines the effects of agreement, incentive, or presentation modifications and the effect of such modifications on customers, customer buying habits, store or business results, or any other measures, including, for example, testing for dilution, diversion, accretion, gaming or fishing. In one embodiment, one or more of the above operations are performed using the AIP.

In one embodiment, a system administrator is able to enter or modify or delete or otherwise provide transaction histories, agreements, incentives, or presentations using an interface provided for such purposes. When establishing messages or content of transaction histories, agreements, incentives, or presentations, such administrator or other end user may be further permitted to designate which transaction histories, agreements, incentives, or presentations are to be generally used when using a particular type of communications. For example, one type of transaction history, agreement, incentive, or presentation may be designated for use when communicating via cell phone and another transaction history, agreement, incentive, or presentation used for email and still other versions for each or all of the other various methods of communications. In another embodiment, the present invention tests each transaction history, agreement, incentive, or presentation with each such communications method to determine, partially or wholly, which transaction history, agreement, incentive, or presentation yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method. In a further embodiment, one or more of the above operations are performed using the AIP.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware:
a. Central Controller or Local Controllers. The present invention can be managed by a central system on behalf of multiple business entities or locations or systems associated with portions of the multiple business entities or locations can implement the present invention.
b. Retailer System 1-n
c. End User Device 1-n

2. Software:
a. Agreement Program: generates agreements; modifies agreements, for example, based on transaction histories; generates and modifies presentations for agreements; accepts offers for agreements and modifies offered agreements as applicable; and manages agreements. Uses artificial intelligence, for example, generic algorithms, as applicable.
b. Incentive Program: generates incentives; modifies incentives, for example, based on transaction histories; generates and modifies presentations for incentives; and manages incentives.

The following is a listing of exemplary data bases that can be used in a present invention method or system. It should be understood that a present invention method or system is not limited to any or all of the databases shown and that other databases are included in the spirit and scope of the claimed invention.

Transaction Database—stores transaction data, including subscription/agreement program data.

Consumer/customer Database—stores consumer/customer data, including subscription program data and transaction histories.

Inventory Database—stores inventory information.

Offer Database—stores available agreements and incentives.

Offer Rules Database—stores rules for generating and modifying agreements and incentives.

Live Offers Database—stores active subscription/agreement programs.
Complaints
Cancellation
Modification request
Revenue
Profit
Manufacturer Subsidy
Reminders 1-n
Products 1-n-
Retailers 1-n
Rules 1-n
Conditions 1-n
Penalties 1-n
Consumers 1-n
Credit Cards to Secure Offer 1-n

It is to be understood that the embodiments and variations shown and described herein are merely illustrative of the principles of this invention and that various modifications may be implemented by those skilled in the art without departing from the scope and the spirit of the invention. For example, while the invention has been illustrated as being implemented using particular computer systems including hardware components such as a computer, POS terminals, portable employee terminals, and input and output devices, the invention could also be implemented using other hardware components and/or other interconnections between such components. Also, while the invention has been described as being implemented using a computer, some or all of the functionality could alternatively reside in a POS terminal or other computing device (e.g., a headset). The invention could also be implemented using discrete hardwired components instead of computers. Further, while the above description refers to particular databases, other databases or data structures could be used. In addition, while various embodiments of methods in accordance with the invention have been discussed which include specific steps listed in specific orders, a person of skill in the art will recognize that these steps can be performed in different combinations and orders. While other modifications will be evident to those skilled in the art, the present invention is intended to extend to those modifications that nevertheless fall within the scope of the appended claims.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for managing a purchase agreement, comprising:
storing, in a memory element for at least one specially-programmed general purpose computer, a first purchase agreement between a customer and at least one business entity, the first purchase agreement including at least one first requirement regarding at least one first retail transaction between the customer and the at least one business entity;
compiling, using a processor in the at least one specially-programmed general purpose computer, a first purchasing history for the customer with respect to the at least one business entity and the first purchase agreement;
storing the first purchasing history in the memory element;
modifying, using the processor, the first purchasing history, and an artificial intelligence program (AIP) stored in the memory element, the at least one first requirement to increase revenue or profitability of the at least one business entity; and,
transmitting, using an interface element in the at least one specially-programmed general purpose computer, the modified at least one first requirement for presentation to the customer.

2. The method of claim 1 further comprising:
modifying the at least one first requirement using an operational or financial parameter regarding the at least one business entity; or,
generating, using the processor and the AIP, the first purchase agreement to optimize revenue or profitability of the at least one business entity.

3. The method of claim 2 wherein generating the first purchase agreement includes using an operational or financial parameter regarding the at least one business entity, or using a second purchasing history for the first customer.

4. The method of claim 1 further comprising:
storing, in the memory element, a second purchase agreement between the customer and the at least one business entity, the second purchase agreement including at least one second requirement regarding at least one second retail transaction between the customer and the at least one business entity;
compiling, using the processor, a second purchasing history for the customer with respect to the at least one business entity and the at least one second purchase agreement;
storing the respective second purchasing history in the memory element;
determining, using the processor and the first and second purchasing histories, a relative profitability of the first and second purchasing agreements; and,
modifying, using the processor, the relative profitability, and the AIP, the first or second requirement to increase revenue or profitability of the at least one business entity.

5. The method of claim 1 further comprising:
receiving, using the interface element, an offer from the customer to enter into a third purchase agreement with the at least one business entity, the third purchase agreement including at least one third requirement regarding at least one third retail transaction between the customer and the at least one business entity;
determining, using the processor, a profitability of the third purchase agreement;
for a profitability less than a specified value, modifying, using the processor and the AIP, the at least one third requirement to increase revenue or profitability of the at least one business entity; and,
transmitting, using the interface element, the modified at least one third requirement.

6. The method of claim 1 further comprising determining, using the processor and the AIP, an incentive with respect to compliance with the first purchase agreement and wherein transmitting the modified at least one first requirement includes transmitting the incentive.

7. A method for managing a purchase agreement, comprising:
generating, using a processor in at least one specially-programmed general purpose computer and an artificial intelligence program (AIP) stored in a memory element for the at least one specially-programmed general purpose computer, a first purchase agreement between a customer and at least one business entity, the first purchase agreement to increase revenue or profitability of the at least one business entity and including at least one first requirement regarding at least one first retail transaction between the customer and the at least one business entity;
compiling, using a processor in the at least one specially-programmed general purpose computer, a first purchasing history for the customer with respect to the at least one business entity and the first purchase agreement;
storing the first purchasing history in the memory element;
modifying, using the processor, the first purchasing history, and the AIP, the at least one first requirement to increase revenue or profitability of the at least one business entity; and,
transmitting, using an interface element in the at least one specially-programmed general purpose computer, the modified at least one first requirement for presentation to the customer.

8. The method of claim 7 further comprising:
generating or modifying the at least one first requirement using a first operational or financial parameter regarding the at least one business entity; or,
generating the first purchase agreement using a second purchasing history for the customer.

9. The method of claim 7 further comprising:
storing, in the memory element, a second purchase agreement between the customer and the at least one business entity, the second purchase agreement including at least one second requirement regarding at least one second retail transaction between the customer and the at least one business entity;
compiling, using the processor, a second purchasing history for the customer with respect to the at least one business entity and the at least one second purchase agreement;
storing the second purchasing history in the memory element;
determining, using the processor and the first and second purchasing histories, a relative profitability of the first and second purchasing agreements; and,
modifying, using the processor, the relative profitability, and the AIP, the at least one first or second requirement to increase revenue or profitability of the at least one business entity.

10. The method of claim 7 further comprising:
receiving, using the interface element, an offer from the customer to enter into a third purchase agreement with the at least one business entity, the third purchase agreement including at least one third requirement regarding at least one third retail transaction between the customer and the at least one business entity;
determining, using the processor, a profitability of the respective third purchase agreement;
for a profitability less than a specified value, modifying the at least one third requirement using the processor and the AIP; and,
transmitting, using the interface element, the modified at least one third requirement for presentation to the customer.

11. The method of claim 7 further comprising determining, using the processor and the AIP, an incentive with respect to compliance with the first purchase agreement and wherein transmitting the modified at least one first requirement includes transmitting the incentive.

12. A method for managing a purchase agreement, comprising:
receiving, using an interface element for at least one specially-programmed general purpose computer, an offer from a customer to enter into a purchase agreement with at least one business entity, the first purchase agreement including at least one first requirement regarding at least one first retail transaction between the customer and the at least one business entity;
determining, using a processor for the at least one specially-programmed general purpose computer, a profitability of the first purchase agreement;
for a profitability less than a specified value, modifying, using the processor and an artificial intelligence program (AIP) stored in a memory element for the at least one specially-programmed general purpose computer, the at least one first requirement to increase revenue or profitability of the at least one business entity; and,
transmitting, using the interface element, the modified at least one first requirement for presentation to the customer.

13. The method of claim 12 further comprising:
compiling, using the processor, a purchasing history for the first customer with respect to the at least one business entity and the modified at least one first requirement;
storing the purchasing history in the memory element;
modifying, using the processor, the purchasing history, and the AIP, the modified at least one first requirement to increase revenue or profitability of the at least one business entity; and,
transmitting, using the interface element, the further modified at least one first requirement for presentation to the at least one first customer.

14. The method of claim 12 further comprising modifying the at least one first requirement using an operational or financial parameter regarding the at least one business entity.

15. The method of claim 12 further comprising:
compiling, using the processor, a first purchasing history for the first customer with respect to the at least one business entity and the modified at least one first requirement;
storing the purchasing history in the memory element;
storing, in the memory element, a second purchase agreement between the customer and the at least one business entity, the second purchase agreement including at least one second requirement regarding at least one second retail transaction between the customer and the at least one business entity;
compiling, using the processor, a second purchasing history for the customer with respect to the at least one business entity and the at least one second purchase agreement;
storing the respective second purchasing history in the memory element;
determining, using the processor and the first and second purchasing histories, a relative profitability of the first and second purchasing agreements; and,
modifying, using the processor, the relative profitability, and the AIP, the at least one first or second requirement to increase revenue or profitability of the at least one business entity.

16. The method of claim 12 further comprising determining, using the processor and the AIP, an incentive with respect to compliance with the first purchase agreement and wherein transmitting the modified at least one first requirement includes transmitting the incentive.

17. A system for managing a purchase agreement, comprising:
a memory element for at least one specially-programmed general purpose computer for storing an artificial intelligence program (AIP) and a first purchase agreement between a customer and at least one business entity, the first purchase agreement including at least one first requirement regarding at least one first retail transaction between the customer and the at least one business entity;
a processor in the at least one specially-programmed general purpose computer for:
compiling a first purchasing history for the customer with respect to the at least one business entity and the first purchase agreement, the memory element for storing the first purchasing history; and,
modifying, using the first purchasing history and the AIP, the at least one first requirement to increase revenue or profitability of the at least one business entity; and,
an interface element in the at least one specially-programmed general purpose computer for transmitting the modified at least one first requirement for presentation to the customer.

18. The system of claim 17 wherein the processor is for:
modifying the at least one first requirement using an operational or financial parameter regarding the at least one business entity; or,
generating, using the processor and the AIP, the first purchase agreement to optimize revenue or profitability of the at least one business entity.

19. The system of claim 17 wherein the processor is for generating the first purchase agreement using an operational or financial parameter regarding the at least one business entity, or using a second purchasing history for the first customer.

20. The system of claim 17 wherein the memory element is for storing a second purchase agreement between the customer and the at least one business entity, the second purchase agreement including at least one second requirement regarding at least one second retail transaction between the customer and the at least one business entity; and wherein the processor is for:
compiling a second purchasing history for the customer with respect to the at least one business entity and the at least one second purchase agreement, the memory element for storing the respective second purchasing history in the memory element;
determining, using the first and second purchasing histories, a relative profitability of the first and second purchasing agreements; and,
modifying, using the relative profitability and the AIP, the first or second requirement to increase revenue or profitability of the at least one business entity.

21. The system of claim 17 wherein the interface element is for receiving an offer from the customer to enter into a third purchase agreement with the at least one business entity, the third purchase agreement including at least one third requirement regarding at least one third retail transaction between the customer and the at least one business entity, wherein the processor is for:
determining a profitability of the third purchase agreement; and,
for a profitability less than a specified value, modifying, using the processor and the AIP, the at least one third requirement to increase revenue or profitability of the at least one business entity, wherein the interface element is for transmitting the modified at least one third requirement.

22. The system of claim 17 wherein the processor is for determining, using the AIP, an incentive with respect to compliance with the first purchase agreement and wherein the interface element is for transmitting the incentive with the modified at least one first requirement.

23. A system for managing a purchase agreement, comprising:
a memory element for at least one specially-programmed general purpose computer for storing an artificial intelligence program (AIP);
a processor for the at least one specially-programmed general purpose computer for:
generating, using the AIP, a first purchase agreement between a customer and at least one business entity, the first purchase agreement to optimize revenue or profitability of the at least one business entity and including at least one first requirement regarding at least one first retail transaction between the customer and the at least one business entity;
compiling a first purchasing history for the customer with respect to the at least one business entity and the first purchase agreement, the memory element for storing the first purchasing history; and,
modifying, using the first purchasing history and the AIP, the at least one first requirement to increase revenue or profitability of the at least one business entity; and,
an interface element in the at least one specially-programmed general purpose computer for transmitting, the modified at least one first requirement for presentation to the customer.

24. The system of claim 23 wherein the processor is for:
generating or modifying the at least one first requirement using a first operational or financial parameter regarding the at least one business entity; or,
generating the first purchase agreement using a second purchasing history for the customer.

25. The system of claim 23 wherein the memory element is for storing a second purchase agreement between the customer and the at least one business entity, the second purchase agreement including at least one second requirement regarding at least one second retail transaction between the customer and the at least one business entity, and wherein the processor is for:
compiling a second purchasing history for the customer with respect to the at least one business entity and the at least one second purchase agreement, the memory element for storing the second purchasing history in the memory element;
determining, using the first and second purchasing histories, a relative profitability of the first and second purchasing agreements; and,
modifying, using the relative profitability and the AIP, the at least one first or second requirement to increase revenue or profitability of the at least one business entity.

26. The system of claim 23 wherein the interface element is for receiving an offer from the customer to enter into a third purchase agreement with the at least one business entity, the third purchase agreement including at least one third requirement regarding at least one third retail transaction between the customer and the at least one business entity, and wherein the processor is for:
determining a profitability of the respective third purchase agreement; and
for a profitability less than a specified value, modifying the at least one third requirement using the processor and the AIP, and wherein the interface element is for transmitting the modified at least one third requirement for presentation to the customer.

27. The system of claim 23 wherein the processor is for determining, using the AIP, an incentive with respect to compliance with the first purchase agreement and wherein the interface element is for transmitting the incentive with the modified at least one first requirement.

28. A system for managing a purchase agreement, comprising:
an interface element for at least one specially-programmed general purpose computer for receiving an offer from a customer to enter into a purchase agreement with at least one business entity, the first purchase agreement including at least one first requirement regarding at least one first retail transaction between the customer and the at least one business entity;
a memory element for the at least one specially-programmed general purpose computer for storing an artificial intelligence program (AIP); and,
a processor for the at least one specially-programmed general purpose computer for:
determining a profitability of the first purchase agreement; and,
for a profitability less than a specified value, modifying, using the AIP, the at least one first requirement to increase revenue or profitability of the at least one business entity, and wherein the interface element is for transmitting the modified at least one first requirement for presentation to the customer.

29. The system of claim 28 wherein the processor is for compiling a purchasing history for the first customer with respect to the at least one business entity and the modified at least one first requirement, wherein the memory element is for storing the purchasing history in the memory element, wherein the processor is for modifying, using the purchasing history and the AIP, the modified at least one first requirement to increase revenue or profitability of the at least one business entity, and wherein the interface element is for transmitting the further modified at least one first requirement for presentation to the at least one first customer.

30. The system of claim 28 wherein the processor is for modifying the at least one first requirement using an operational or financial parameter regarding the at least one business entity.

31. The system of claim 28 wherein the processor is for compiling a first purchasing history for the first customer with respect to the at least one business entity and the modified at least one first requirement, wherein the memory element is for storing the purchasing history and storing a second purchase agreement between the customer and the at least one business entity, the second purchase agreement including at least one second requirement regarding at least one second retail transaction between the customer and the at least one business entity, wherein the processor is for compiling a second purchasing history for the customer with respect to the at least one business entity and the at least one second purchase agreement, wherein the memory element is for storing the respective second purchasing history, wherein the processor is for:
determining, using the first and second purchasing histories, a relative profitability of the first and second purchasing agreements; and,
modifying, using the relative profitability and the AIP, the at least one first or second requirement to increase revenue or profitability of the at least one business entity.

32. The system of claim 28 wherein the processor is for determining, using the processor and the AIP, an incentive with respect to compliance with the first purchase agreement and wherein the interface element is for transmitting the incentive with the modified at least one first requirement.
